(19) United States
(12) Patent Application Publication
(10) Pub. No.: US 2011/0231771 A1
(43) Pub. Date: Sep. 22, 2011

(54) SYSTEMS AND METHODS FOR ENCOURAGING RESPONSIBLE ONLINE BEHAVIOR

(76) Inventor: Tom C. Tovar, San Francisco, CA (US)

(21) Appl. No.: 12/897,693

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 3/01

(52) U.S. Cl. 715/736

(57) ABSTRACT

Systems and methods for encouraging responsible online behavior may include a user interface module to provide a user interface between a network user with administrative authority and an Internet service, a communication module to receive, from the network user with administrative authority via the user interface, advisory parameters to establish an advisory policy for the Internet service, a policy generating module to establish the advisory policy for the network, and a policy enforcement module to apply the advisory policy to a network user request to access an Internet content.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

This application relates generally to data processing and more specifically to systems and methods for encouraging responsible online behavior.

### BACKGROUND

Internet overuse is commonplace and manifests itself in excessive gaming, social networking, blogging, and email use. Users with compulsive behaviors may engage in even more troublesome online activities such as uncontrolled gambling and shopping. Excessive online gambling and shopping may ruin a family's finances. Often other family members may become worried that the continued and increasingly excessive use of online gambling and shopping websites by a family member will lead to a financial strain long before this destructive consequence happens. A financial strain is often one of the principle causes of discord between household members. Additionally, Internet overuse in general may affect emotional stability of household members.

Some existing solutions may involve filtering online content. Filters may, for example, be implemented by a software program installed on a personal computer and designed to restrict content delivered over the Internet. However, instead of encouraging responsible online behavior, such existing solutions merely block the problematic content, which may result in resentment of the target user and further aggravation of the problem.

### BRIEF DESCRIPTION OF THE DRAWINGS

Exemplary embodiments are illustrated by way of example and not limitation in the figures of the accompanying drawings, in which like references indicate similar elements.

FIG. 1 is a block diagram of an advisory policy engine, in accordance with various embodiments of the present technology.

FIG. 2 illustrates a flow chart of a method for encouraging responsible online behavior.

FIG. 3 is a screenshot of a description associated with an advisory policy application.

FIG. 4 is a screenshot of a configuration webpage to provide configuration parameters associated with an advisory policy.

FIG. 5 is a screenshot of a confirmation webpage to confirm advisory policy settings.

FIG. 6 is a screenshot of an intermediary webpage that may appear in the event that requested Internet content is associated with the advisory policy.

FIG. 7 is a block diagram of a Domain Name Server (DNS) environment.

FIG. 8 is a block diagram of a system within which an advisory policy is implemented.

FIG. 9 is a computing system that may be used to implement the methods for restricting online access.

### DETAILED DESCRIPTION

Systems and methods for encouraging responsible online behavior may be implemented at a network level to encourage users to engage in unacceptable online behavior. In many cases, the effects of habits are not limited to adverse effects on their own banking accounts. For example, problems may occur within a relationship if one person is constantly spending money, thereby forcing the other person to assist financially.

A user with administrative authority may utilize an exemplary system to communicate a concern related to online habits to one or more family members in an attempt to encourage responsible online behavior. It may be useful to send digital reminders of desired behaviors. For example, parents of children with their first credit card and couples with their first joint account may find it useful to place these digital reminders in advance of accessing websites where credit card use may occur. Likewise, families may find it appropriate to guide users with any sort of message from household rules to supportive messages before users enter websites considered problematic.

Youths are often unaware of the consequences that come with accruing debt. This can lead to financial ruin later in their lives. The systems and methods for encouraging responsible online behavior may help raise financially responsible children by allowing parents to encourage responsible online behavior and teach their children to be financially responsible.

Once an exemplary system for encouraging responsible online behavior is implemented, when a user attempts to access a website (e.g., a shopping website or a gambling website) determined to be problematic, the requesting user may be redirected to an intermediary Internet site. The intermediary Internet site may provide a reminder concerning the dangers of accessing the content of the intended website. Which website or website categories are problematic may be determined by an advisory policy based on the configuration parameters provided by a user with administrative authority. Because the system is implemented at the network level, any person utilizing the network to access online content may be subjected to the same advisory policy regardless of the specific device used for the access.

The systems and methods for encouraging responsible online behavior may encourage responsible Internet use, particularly in the case of excessive online shopping, online gambling, or other uses that threaten financial or emotional stability. Additionally, the systems and methods may be used to remind a family member of an offline agreement prior to entering a website or to have the family member enter the website with a supportive message or guideline for appropriate use in mind. Thus, systems and methods for encouraging responsible online behavior may provide a digital checkpoint to discourage excessive use and provide a user with constructive reinforcement for desired behavior.

The following detailed description includes references to the accompanying drawings, which form a part of the detailed description. The drawings show illustrations in accordance with exemplary embodiments. These exemplary embodiments, which may be referred to herein as “examples,” are described in enough detail to enable those skilled in the art to practice the present subject matter. The embodiments can be combined, and other embodiments can be formed, by introducing structural and logical changes without departing from the scope of what is claimed. The following detailed description is, therefore, not to be taken in a limiting sense and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Generally speaking, a user with administrative authority may create and enforce mediation polices for one or more end users that utilize computing devices coupled to an Internet service delivered to a location such as a home, residence or place of business or campus. The term “administrator” may include not only individuals, such as parents, but also any individual creating a mediation policies regarding the Internet service delivered to end users. It will be understood that an administrator may also be an end user, although end users who are not also administrators may not create or apply policies.

It will be further understood that because of the diversity of computing devices that may connect to the Internet service, the policy may be applied to the Internet service rather than requiring the policy to affect each computing device individually, such as a mediation application resident on each computing device. In various exemplary embodiments a policy may also reside as a stand alone application on one or more of the computing devices.

Exemplary user devices for use with the disclosed systems may have an app. As used herein, an app shall be defined as a module including a user interface to an Internet service. The app may further include one or modules included in the Internet service. An app may be downloaded and installed on a user's computing device, including mobile devices. Users may define mediation policy via a user device, such as through the user interface. Some embodiments of the present invention do not require software to be downloaded or installed locally to the user device and, accordingly, do not require the user to execute a de-install application to cease use of the system.

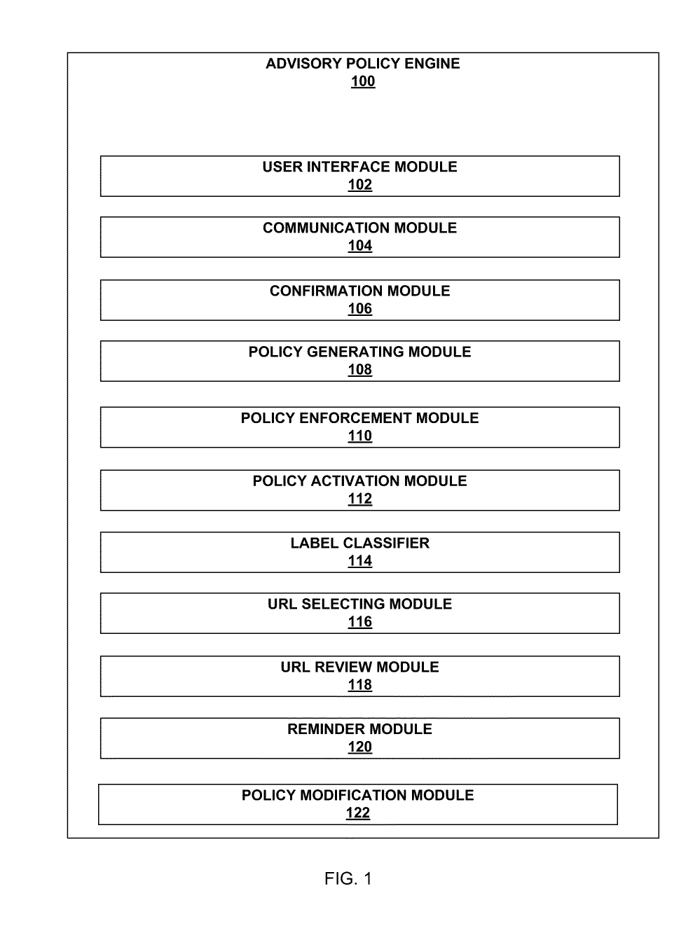

FIG. 1 is a block diagram of an advisory policy engine 100, in accordance with various exemplary embodiments of the technology. Alternative embodiments of the advisory policy engine 100 may comprise more, less, or functionally equivalent modules. In some exemplary embodiments, the advisory policy engine 100 may include a user interface module 102, a communication module 104, a confirmation module 106, a policy generating module 108, a policy enforcement module 110, a policy activation module 112, a label classifier 114, a Uniform Resource Locator (URL) selecting module 116, a URL review module 118, a reminder module 120, and a policy modification module 122. It will be appreciated by one of ordinary skill that examples of the foregoing modules may be virtual and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

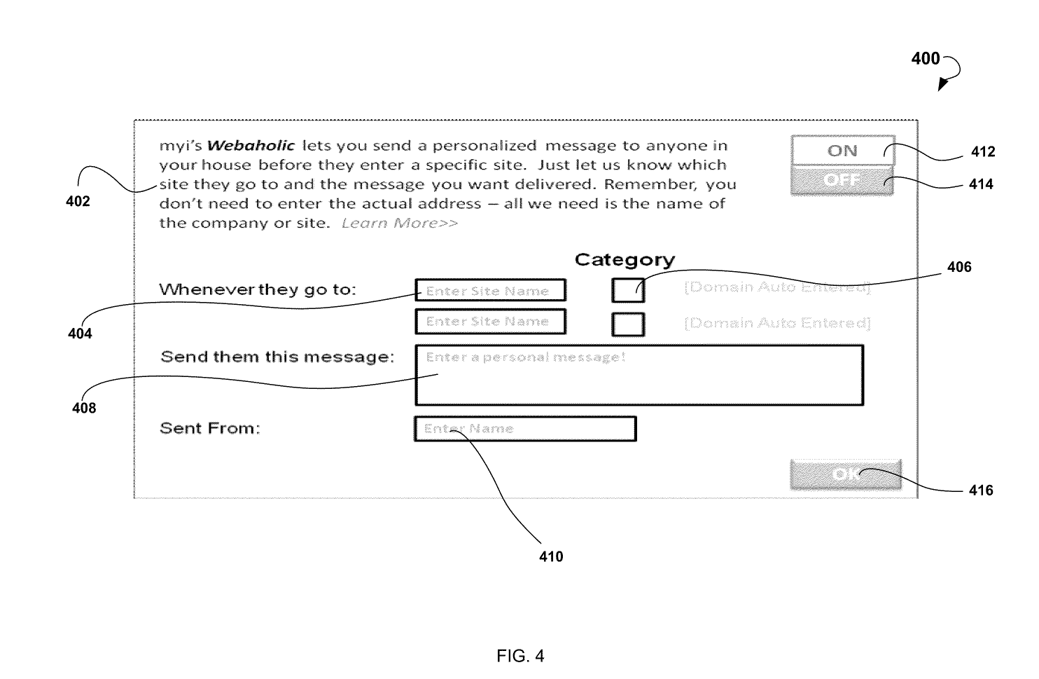

The user interface module 102 may be configurable to establish a user interface 810, which may be utilized by a network user 760 with administrative authority at a user device 750. The network user 760 with administrative authority may utilize the user interface 810, generated by the user interface module 102, to configure the advisory policy with various parameters. The user interface module 102 may also enable the network user 760 with administrative authority to activate and deactivate the advisory policy, for example, by using ON and OFF buttons. A network user 760 being targeted by the advisory policy may utilize the user interface module 102 to review the advisory policy and to either continue on to the intended content or heed the advice and restrain from accessing the intended content. An exemplary configuration of the advisory policy is described in more detail below with reference to FIG. 4.

It should be understood that the advisory policy may not necessarily be intended as a blocking mechanism. The network user 760 may believe that his or her behavior is under control. Accordingly, the network user 760 may be allowed to continue to the intended website after viewing an intermediary page containing a message via the user interface 810. Thus, instead of blocking the intended website, the advisory policy provides the network user 760 with encouragement to engage in a responsible online behavior. Because the advisory policy may be established at a network level, the policy may also be applied to a network.

The communication module 104 may be configurable to provide a communication channel between the advisory policy engine 100 and various other components. Additionally, the communication module 104 may facilitate the direct exchange of information between various modules of the advisory policy engine 100. For example, the communication module 104 may facilitate receiving advisory configurations provided by the network user 760 with administrative authority via the user interface 810.

When the network user 760 with administrative authority submits the configurations associated with the advisory policy, the policy generating module 108 may generate an appropriate advisory policy. For example, in response to the network user 760 with administrative authority entering “gambling” as a category of Internet content he would like discourage and checking the category check box, the policy generating module 108 may generate an advisory policy which will attempt to discourage the network user 760 from accessing websites falling in the gambling category.

In some exemplary embodiments, the confirmation module 106 may be configurable to confirm the advisory policy with the network user 760 with administrative authority after the configurations are saved and/or enabled and the policy generating module 108 generates the advisory policy. When the network user 760 attempts to access the website which is considered problematic by the advisory policy engine 100, the advisory policy may be enforced by the policy enforcement module 110. It should be appreciated that in some exemplary embodiments, saving advisory policy configurations may not automatically activate the associated advisory policy. Therefore, the policy activation module 112 may be utilized to activate the advisory policy. The policy activation module 112 may also be utilized to deactivate the advisory policy if the network user 760 with administrative authority decides to terminate the advisory policy.

In order to specify the advisory policy, the network user 760 with administrative authority may enter a website name or a website category as a label. The label classifier 114 may be utilized to determine the type of the input received from the network user 760 with administrative authority. In some exemplary embodiments, the network user 760 with administrative authority may explicitly indicate the type of the input by selecting the category checkbox. Based on whether the network user 760 with administrative authority wishes to enforce the advisory policy with respect to a specific website or a website category, the URL selecting module 116 may determine which website or website category is most closely aligned with the request of the network user 760 with administrative authority. To ensure that the correct websites or website categories are selected by the URL selecting module 116, the URL review module 118 may enable the network user 760 with administrative authority to review and modify the one or more URLs associated with the advisory policy. If the network user 760 with administrative authority does not believe that the selected URLs align with his or her intended content, he or she can modify the selection by removing and/or adding URLs and/or categories of URLs.

When the network user 760 attempts to access a website, the policy enforcement module 110 may determine that the advisory policy is active and that the intended website is covered by the advisory policy. Upon such determination, the reminder module 120 may remind the network user 760 of the advisory policy by providing an intermediary Internet site. The intermediary Internet site may advise the network user 760 against accessing the intended website. Additionally, the reminder module 120 may periodically send a reminder to the network user 760 accessing the Internet content, advising the network user against accessing the Internet content.

Based on observed results, the network user 760 with administrative authority may wish to modify the parameters throughout the course of the use of the advisory policy. The policy modification module 122 may allow modifying the advisory policy to alter the website or the website category specified by the network user 760 with administrative authority, thereby targeting the Internet content considered to be problematic.

The ability to make modifications may be important because the network user 760 with administrative authority may not be completely sure whether the initial settings cover the appropriate content. Instead, the network user 760 with administrative authority may make educated guesses as to what websites or website categories are problematic with respect to one or more network users 760. If the initial advisory policy does not cover the appropriate content, the network user 760 with administrative authority may wish to change or apply additional settings to the advisory policy. This trial and error process may be repeated until the desired results are achieved.

Thus, the network user 760 with administrative authority may alter the Internet content that is covered by the advisory policy by accessing the settings and adding new Internet content and/or deleting previously entered Internet content.

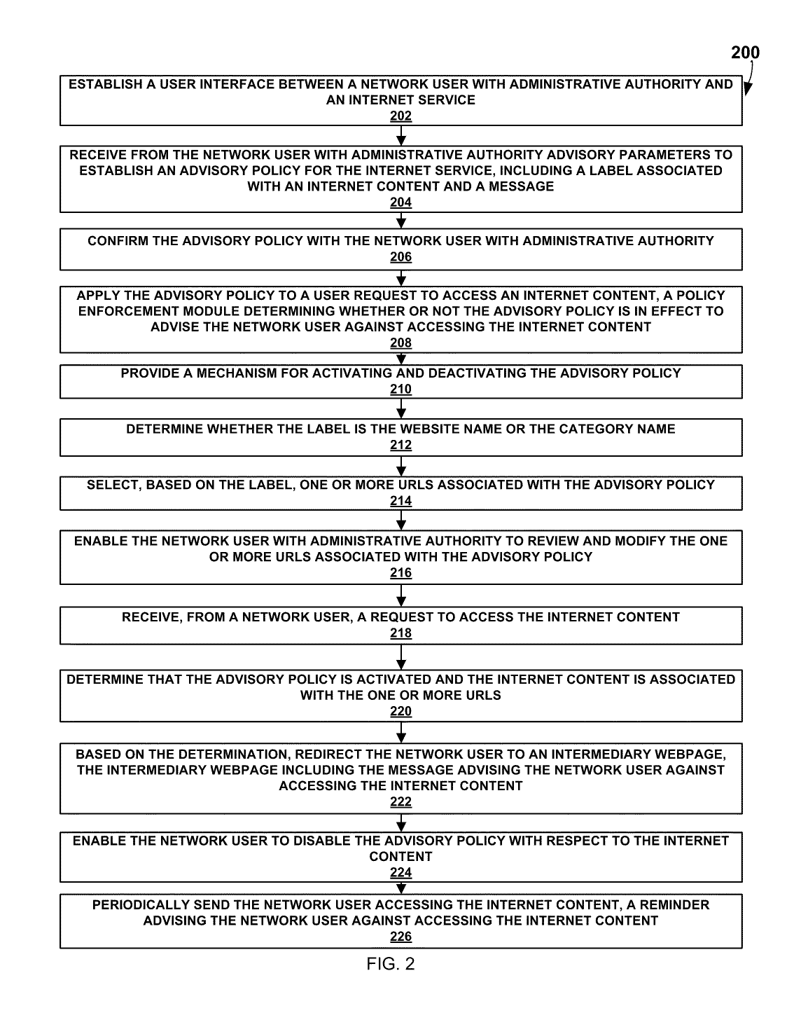

FIG. 2 illustrates a flow chart of a method 200 for encouraging responsible online behavior in accordance with an exemplary embodiment. The method 200 may be performed by processing logic that may comprise hardware (e.g., dedicated logic, programmable logic, microcode, etc.), software (such as run on a general-purpose computer system or a dedicated machine), or a combination of both. In one exemplary embodiment, the processing logic resides at the advisory policy server 100 as illustrated in FIG. 1.

The method 200 may be performed by the various modules discussed above with reference to FIG. 1. Each of these modules may comprise processing logic. The method 200 may commence at operation 202 with the user interface module 102 establishing the user interface 810 between the network user 760 with administrative authority and an Internet service. At operation 204, the communication module 104 may receive advisory parameters from the network user 760 with administrative authority, in order to establish an advisory policy for the Internet service, including a label associated with an Internet content and a message. The label may include a website name or a category name.

At operation 206, the confirmation module 106 may confirm the advisory policy with the network user 760 with administrative authority by displaying a confirmation overlay. The network user 760 with administrative authority may confirm the advisory policy as specified or go back to the configuration webpage and modify the settings. At operation 208, the policy enforcement module 110 may apply the advisory policy to the user 760 request to access an Internet content. The policy enforcement module 110 may determine whether or not the advisory policy is in effect to advise the network user 760 against accessing the Internet content.

If the user 760 with administrative authority wishes to activate or deactivate the advisory policy, at operation 210, the policy modification module 122 may provide a mechanism for activating and deactivating the advisory policy. At operation 212, the label classifier 114 may determine whether the label is the website name or the category name. At operation 214, the URL selecting module 116 may select, based on the label, one or more URLs associated with the advisory policy.

At operation 216, the URL review module 118 may enable the network user 760 with administrative authority to review and modify the one or more URLs associated with the advisory policy. At operation 218, the communication module 104 may receive, from the network user 760, a request to access the Internet content. At operation 220, the policy enforcement module 110 may determine that the advisory policy is activated and the Internet content is associated with the one or more URLs.

If the policy enforcement module 110 determines at operation 220 that the advisory policy is activated and the Internet content is associated with the one or more URLs, at operation 222 the policy enforcement module 110 may redirect the network user to an intermediary Internet site. The intermediary Internet site may include a message advising the network user 760 against accessing the Internet content. Thus, the policy enforcement module 110 may redirect the network user 760 to the intermediary page before the network user 760 enters a website or a website category selected by the URL selecting module 116. The intermediary page may include a message from the network user 760 with administrative authority and may provide the network user 760 the ability to continue on to the intended website after viewing the message.

At operation 224, the policy enforcement module 110 may enable the network user 760 to disable the advisory policy with respect to the Internet content. Thus the network user 760 may be able to access the desired site by either disabling the advisory policy functionality for that particular website or bypassing the intermediary page while still allowing future messages to be sent. In the latter case, the redirections may occur only once per website per browsing session, to ensure that the network user 760 choosing to bypass the intermediary page does not receive a duplicate message as they continue to browse the website that prompted the redirection.

In the event that the advisory policy is applied to a category of websites, the network user 760 may be sent to the intermediary page each time they access a new website within the category of websites. At operation 226, the reminder module 120 may periodically send a reminder to the network user 760 accessing the Internet content, advising the network user 760 against accessing the Internet content.

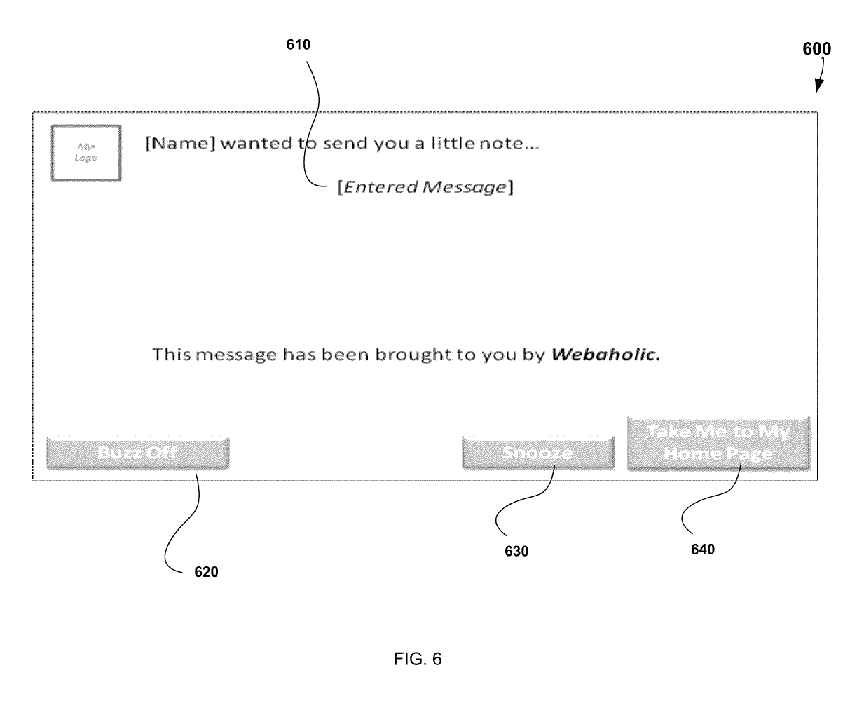

The advisory policy engine 100 may send alerts to the network user 760 with administrative authority when the network user 170 has chosen to disable all future messages from being delivered (e.g., the “Buzz Off” option shown below in FIG. 6). A reporting log may compile information displayed on the intermediary page, the website that prompted the intermediary page, the message delivered, and the date and time the messages were disabled for that particular site. In addition to the aforementioned data captures, the reporting log may also retain an aggregated number of messages sent (e.g., on an annual basis), websites that prompted the messages, messages that are sent, and actions taken by the network user 760 recipient (e.g., number of click-throughs) by website.

The settings associated with the advisory policy, which may include website redirection settings and custom messages, may be saved and maintained until the network user 760 with administrative authority decides to change the settings or disable the advisory policy.

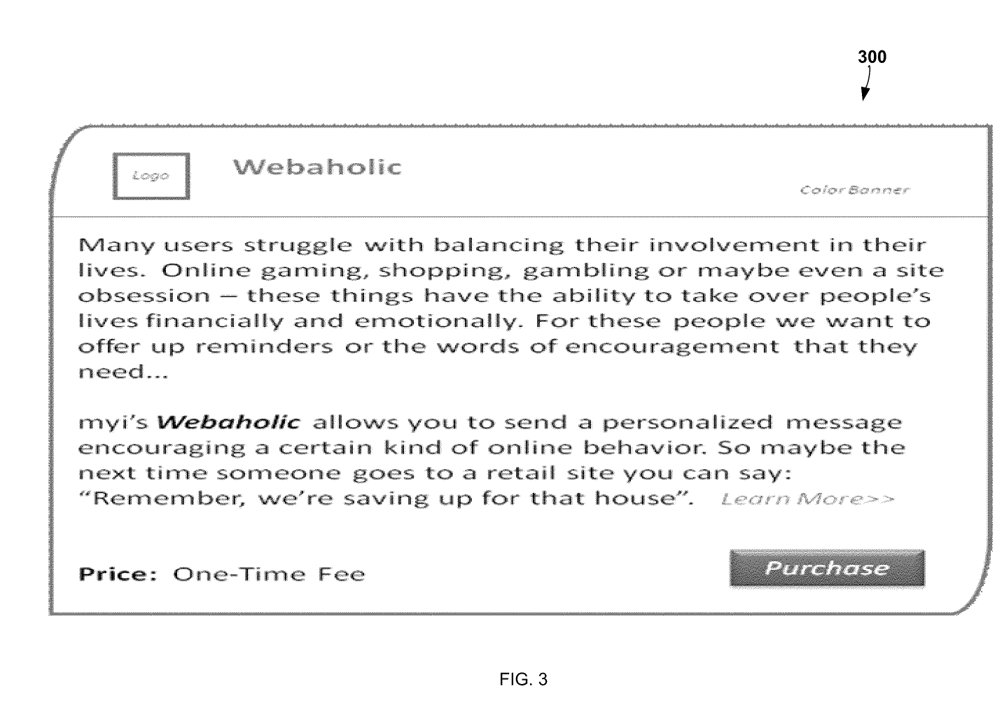

FIG. 3 is a screenshot of a description 300 associated with an advisory policy application, in accordance with an exemplary embodiment. The description 300 may allow the network user 760 with administrative authority to receive information concerning the advisory application. The description 300 may generally describe what the advisory policy does. As shown in FIG. 3, the description 300 may begin with one or more sentences describing the functionality of the advisory policy. In some exemplary embodiments, the description 300 may outline steps in configuring settings for the advisory policy.

FIG. 4 is a screenshot of a configuration webpage 400 that provides configuration parameters associated with an advisory policy. The configuration webpage 400 may be utilized by the network user 760 with administrative authority to provide configuration parameters associated with the advisory policy, in accordance with an exemplary embodiment. In some exemplary embodiments, the configuration webpage 400 may comprise a description text 402, one or more label textboxes 404, one or more “Category” checkboxes 406, a message textbox 408, a sent from textbox 410, an ON button 412, an OFF button 414, and an OK button 416.

The functionality of the advisory policy may be accessible through the configuration webpage 400. The description text 402 may include a brief summary of what the advisory policy does and how the network user 760 with administrative authority may configure it. The description text 402 may begin with one or two sentences describing the functionality of the advisory policy. The description text 402 may then outline steps taken in configuring the settings of the advisory policy.

In some exemplary embodiments, the network user 760 with administrative authority may be able to provide configuration settings by entering a label defining websites that may prompt the intermediary webpage to appear and by entering a message that may be included in the intermediary webpage. Thus, the network user 760 with administrative authority may enter the website name or category of websites of concern and a message they would like delivered when the network user 760 tries to access one of the designated websites.

The network user 760 with administrative authority may enter the website name or category of websites on which the behavior of the network user 760 has raised concern by inputting a label into the label textbox 404. If the label designates a category of websites, a network user 760 with administrative authority may click the “Category” checkbox 406. If the network user 760 with administrative authority does not click the “Category” checkbox 406, the advisory policy engine 100 may assume that the network user 760 with administrative authority has inputted a website. After a website or category name is entered in the label textbox 404, the URL selecting module 116 may automatically populate a URL of a website or a category (in case a category was selected) that aligns most closely with the input provided by the network user 760 with administrative authority.

If the network user 760 with administrative authority determines, upon review, that the selections made by the URL selecting module 116 are incorrect, the network user 760 with administrative authority may click on the selections directly and be presented with a drop down menu filled with other possible selections. It should be noted that when creating their settings, the network user 760 with administrative authority may be allowed to enter a company name, site name, or category of sites (e.g. Bank of America or online games) in the label textbox 404. In some example embodiments, the label classifier 114 may, based on the information provided, automatically determine the intended URL or category of websites that most closely aligns to the request of the network user 760 with administrative authority.

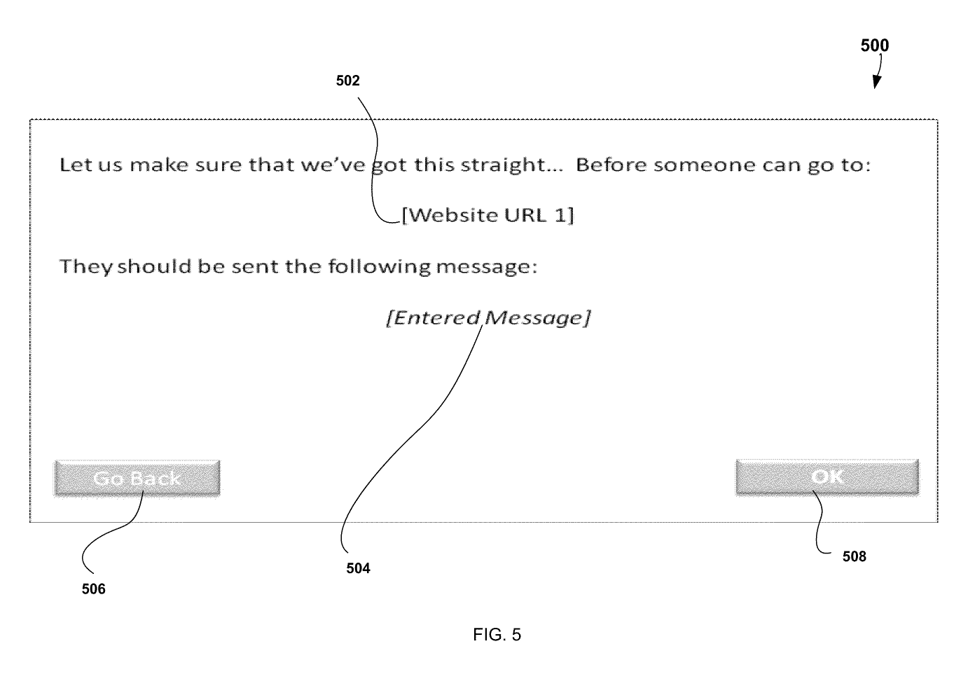

After the network user 760 with administrative authority has made his site selection(s), he may enter a personal message that will be sent to any network user 760 on the network who accesses the chosen websites. The network user 760 with administrative authority may also enter his name in the sent from textbox 410. The network user 760 with administrative authority may click the “OK” button 416 to have the settings stored. After clicking the “OK” button 416, the network user 760 with administrative authority may receive a confirmation overlay as outlined below with reference to FIG. 5.

It should be noted that clicking the “OK” button may not automatically enable the advisory policy. If the network user 760 with administrative authority users input selections but neglects to enable the advisory policy (e.g., by clicking the “ON” button 412), the advisory policy engine 100 may present an overlay (not shown) asking whether the user would like to enable the advisory policy before navigating away from the configuration webpage 400.

FIG. 5 is a screenshot of a confirmation webpage 500, which may be utilized to confirm advisory policy settings, in accordance with an exemplary embodiment. The confirmation webpage 500 may include a website URL 502, a message 504, a “Go Back” button 506, and an “OK” button 508. After the network user 760 with administrative authority clicks the “OK” button 416, they may be presented with the confirmation webpage 500 that asks them to confirm the website URL 502 and the message 504 provided at the configuration webpage 400. If the network user 760 with administrative authority decides that the information is correct, the may click the “OK” button 508, which may save the settings provided at the configuration webpage 400 and close the confirmation webpage 500. If, on the other hand, the network user 760 with administrative authority decides that any of the presented information is incorrect, the network user 760 with administrative authority may be able to click the “Go Back” button 506 to edit their selections in the configuration webpage 400.

FIG. 6 is a screenshot of an intermediary webpage 600 that may appear in the event that an Internet content is associated with the advisory policy, in accordance with an exemplary embodiment. The intermediary webpage 600 may comprise a message 610, a “Buzz Off” button 620, a “Snooze” button 630, and a “Take Me to My Home Page” button 640. If the network user 760 attempts to access a website covered by the advisory policy, he or she may be redirected to the intermediary website 600 that contains the message 610 as entered by the network user 760 with administrative authority at the configuration webpage 400. In some exemplary embodiments, a thumbnail (not shown) of the intended website may also be provided. The intermediary webpage 600 may also include the message 610 and enable the network user 760 to go to their home page by clicking on the “Take Me to My Home Page” button 640, and the ability to continue to the intended site by clicking on the “Snooze” button 630. Additionally, the intermediary webpage 600 may enable the network user 760 to ignore all future messages associated with that Internet content by clicking the “Buzz Off” button 620.

Thus, the intermediary webpage 600 may provide the network user 760 with three options for navigating away from a given website. The network user 760 may be able to go to their home page, disable all reminders for that given working session and continue on to their intended website, or disable all future reminders and continue to their intended website. In the event that the network user 760 chooses to go back to their home page, the advisory policy engine 100 may continue sending the message 610 if another attempt to access the same website occurs.

If the network user 760 chooses to continue on to their intended website but still allows future messages to be sent (by clicking on the “Snooze” button 620), the intermediary webpage 600 may sent a single message per website per browsing session. For example, if the Best Buy website was the triggering site and the network user 760 chooses to bypass the message 610, he or she may not receive the intermediary webpage 600 for that website or any sub-domain during that particular browsing session. A browsing session may be defined as repeated DNS requests for a given website within a certain period of time or a request associated with a session cookie.

If the network user 760 with administrative authority utilizes the advisory policy for a category of websites, any website within that category may trigger a redirection to the intermediary page 600. However, similar to the procedure discussed above, network users 760 may not be redirected to the intermediary webpage 600 more than once per browsing session for a single website. For example, if the network user 760 with administrative authority chooses to redirect all shopping sites, and the network user 760 attempts to access bestbuy.com, he or she may be redirected to the intermediary webpage 600 that contains the message 610. If the network user 760 chooses to bypass the message 610, he or she may be allowed to continue to browse bestbuy.com without receiving another message in that session. If that same network user 760 wishes to compare prices and attempts to access frys.com, he may be redirected to the intermediary webpage 600. If the network user 760 chooses to bypass the message 610, he or she may not be redirected to the intermediary webpage 600 again while accessing any frys.com sub-domain within that same browsing session.

If the network user 760 clicks on the “Buzz Off” button 620, he or she may be opting to continue on to their intended website and disable any future messages from being sent. Should this option be selected, no messages may be sent for that particular website. The network users 760 may not be allowed to disable the messages from being sent to a category of websites.

The systems and methods described above may typically be resident in an Internet service or a DNS network. The systems and methods described may also be implemented in plug-in utilities, gateway devices, cable modems, proxy servers, set top boxes, and network interface devices.

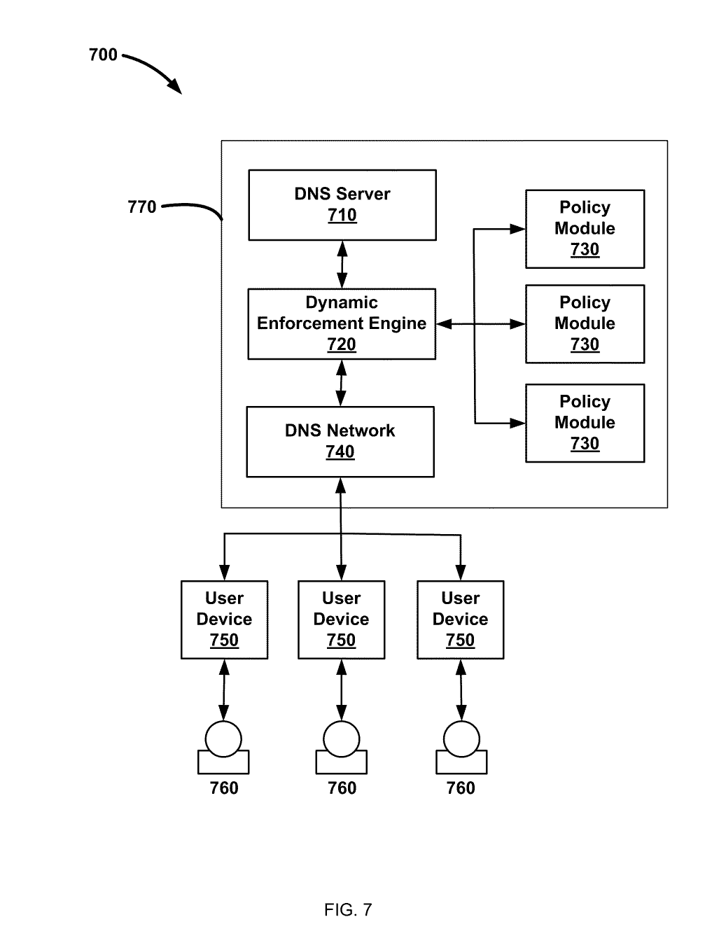

FIG. 7 illustrates an exemplary Internet service system 700, with a DNS server, that may be utilized to support the above described systems and methods. A DNS server 710 operates in conjunction with a dynamic enforcement engine 720. The dynamic enforcement engine 720 may operate in conjunction with one or more policy modules 730 to establish any applicable polices at the DNS server level. The content rules are applied to received user queries, and determine the content that is delivered by the DNS network 740 through various user devices 750 to the network users 760.

The dynamic enforcement engine 720 may generate its policy engine on instructions received from one or more policy modules 730. Each policy module 730 may be constructed to provide various types and levels of services to the DNS network 740. In various embodiments, a policy module 730 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

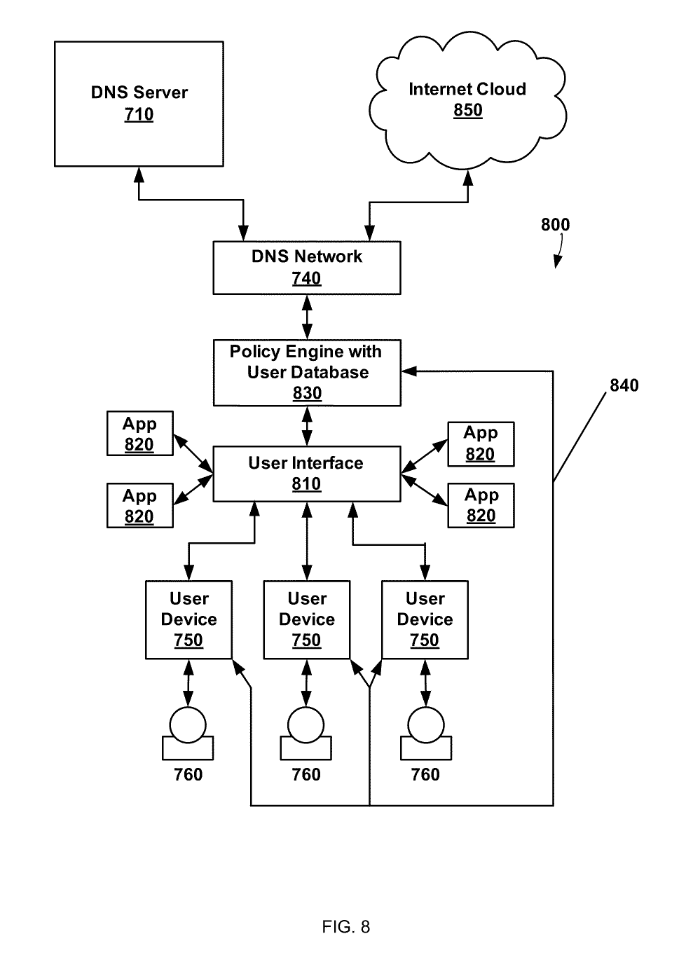

FIG. 8 shows a schematic layout of an exemplary system 800 for implementing direct and variable network user control. FIG. 8 illustrates that the system 800 may operate installed on a DNS server 710, or with a cloud 850 based installation.

The system 800 utilizes a user interface 810. The user interface 810 may be implemented in many embodiments. One specific implementation of the user interface 810 is as a web page.

The user interface 810 may be accessed by one or more user devices 750 operated by the users 760. The user interface 810 may be accessed through a gateway user device available to the users 760. Suitable user devices 750 include, but are not limited to desktops, personal computers (PCs), laptops, tablets, notebooks, gaming devices, IPods, Smartphone, automobile computer systems, and Internet enabled Televisions (TVs). The system 800 may also be deployed, accessed and controlled remotely through user devices 750, such as a Smartphone or other specialized access devices. A Smartphone may be defined as a phone with computing capability. A Smartphone may provide the user 760 with Internet access.

The user interface 810 provides a mechanism for one or more authorized users 760 to establish content policy for the Internet service. The user interface 810 operates between the user devices 750 present in the system 800 and the DNS network 740. Instructions resident on the user interface 810 therefore operate on the Internet service, by controlling at least a portion of DNS resolutions via a dynamic policy engine 830, before the service reaches the displays of the user devices 750.

The user interface 810 provides the users 760 with access to one or more policy applications 820. The user interface 810 may provide access to a selection list to at least one authorized user 760. The authorized user 760 uses the selection list or some other menu mechanism to select those policy applications 820 that the user 760 chooses to apply to the system 800. The authorized user 760 may select any number of the available policy applications for use on the system 800 at any given time. In implementations utilizing Smartphones as the user device 750, the policy applications 820 are downloaded to the user device 750. The device 750 then serves as the user interface 810 to communicate directly with the dynamic policy engine 830.

The policy applications 820 may prohibit access to specific Internet content. The policy applications 820 may also limit the time of day when users or selected users 760 may access certain Internet content. The policy applications 820 may also manage and analyze duration of access to various Internet content. It is important to note that the policy applications 820 do not simply provide blocking mechanisms by masking or enabling network controls, but rather mediate an Internet service received by the network user. As used herein, mediating the service may include any of blocking, constraining, enabling, redirecting, promoting, demoting, substituting, obscuring, limiting, interrupting, and restricting all or a portion of the Internet service. The policy applications 820 may provide notifications or alerts to one or more users 760 when Internet content is accessed. The policy applications 820 may also provide notification of frequency and duration of access of designated Internet content. The policy applications 820 may also be used to observe, substitute, enable, redirect users, reward behavior desired from the users by a system administrator, and so forth. The policy applications 820 may redirect users from a non-favored Internet content to different Internet content. The policy applications 820 may also collect and transmit data characteristic of Internet use.

Access policies supplied by the policy applications 820 may apply to all network users 760 of the system 800, or the access policies may be specific to individual users or groups of network users 760. The policy applications 820 may be discrete, single purpose applications.

The policy applications 820 provide the users 760 with a mechanism to take various actions relative to their Internet service feed. The policy applications 820 also allow the users 760 to establish a dynamic policy engine 830 that includes a user database. The dynamic policy engine 830 is used to enforce rules associated with each policy application associated with individual network users, not simply block various inappropriate Internet content from the Internet feed. Rather, the dynamic policy engine 830, controlled by the user interface 810 through user device(s) 750, is used to manage all aspects of the Internet experience for the users 760. In sum, the policy applications 820 may be used to configure the dynamic policy engine 830 to provide the users 760 with a mechanism to personalize the Internet experience. The policy applications 820 may be configured in combinations, and may each be separately configured.

The database in the dynamic policy engine 830 may be used to record and to notify network users 760 of various data relative to Internet access. The data collected from and provided to the users 760 may include records of access of specific Internet content, time spent on specific Internet content, time of day of access, data specific to individual users, and so forth.

It should also be noted that following an initial setup through the user interface 810 of the dynamic policy engine 830, a direct access 840 enforcement loop may be established between the dynamic policy engine 830 and the user devices 750. Subsequent accessing of the DNS network 740 utilizing the direct access 840 decreases response time in the system 800, thereby further enhancing the Internet experience of the users 760. Configurations of policy applications 820 that are selected by one or more users 760 designated as system administrators may remain in the user database of the dynamic policy engine 830 until such time as it may be modified by the system administrators. The system administrators may define multiple policy configurations, with a combination of policy applications 820, applicable to one or more network users 760 of the system 800. Each policy application 820 may be separately configurable as well. Policy configurations may vary based upon designated times, conditional triggers, or specific requests from the users 760 with administrative authority.

As indicated above, two discrete data flow paths may be established for the system 800. A first data path establishes a set of enforcement policies for the system 700. The first data path flows from at least one user device 750 through the user interface 810 to the policy enforcement engine 720. A second data path 840 may be utilized following the establishment of a set of policies for the system 800. The second data path 840 flows directly between the user device(s) 750 and the policy engine 830. Multiple sets of enforcement policies may be established and saved within the system 800 and implemented selectively by the users 760.

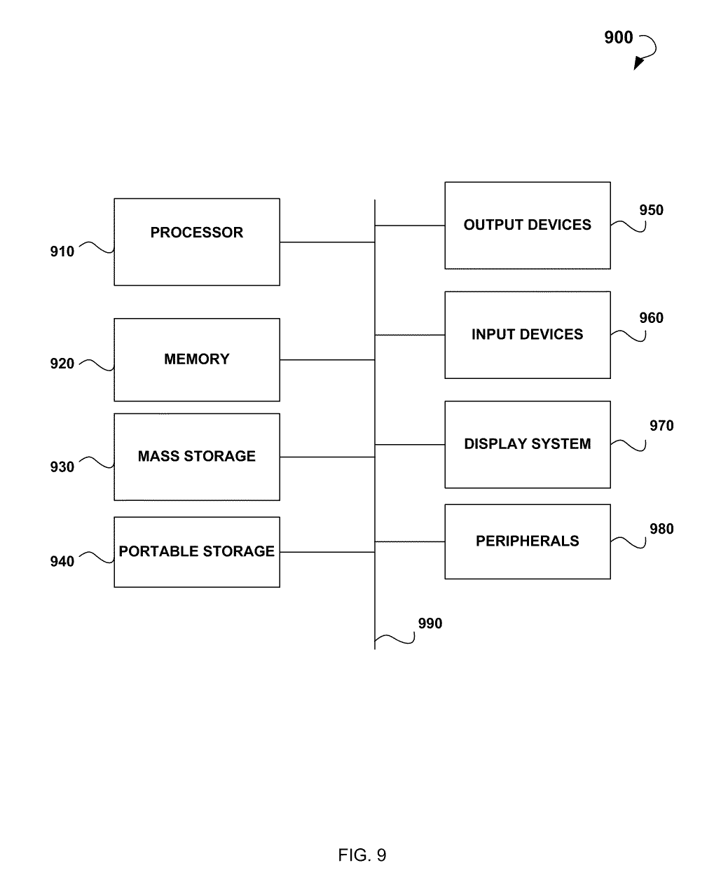

FIG. 9 illustrates an exemplary computing system 900 that may be used to implement an embodiment of the present invention. System 900 of FIG. 9 may be implemented in the context of user devices 750, DNS server 710, Internet cloud 850, and the like. The computing system 900 of FIG. 9 includes one or more processors 910 and memory 920. Main memory 920 stores, in part, instructions and data for execution by processor 910. Main memory 920 can store the executable code when the system 900 is in operation. The system 900 of FIG. 9 may further include a mass storage device 930, portable storage medium drive(s) 940, output devices 950, user input devices 960, a graphics display system 970, and other peripheral devices 980.

The components shown in FIG. 9 are depicted as being connected via a single bus 990. The components may be connected through one or more data transport means. Processor 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor 910. Mass storage device 930 can store the system software for implementing embodiments of the present invention for purposes of loading that software into main memory 920.

Portable storage medium drive 940 operates in conjunction with a portable non-volatile storage medium, such as a floppy disk, compact disk (CD) or digital video disc (DVD), to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Suitable output devices include speakers, printers, network interfaces, and monitors.

Display system 970 may include a liquid crystal display (LCD) or other suitable display devices. Display system 970 receives textual and graphical information and processes the information for output to the display device.

Peripherals 980 may include any type of computer support device to add additional functionality to the computer system. Peripheral device(s) 980 may include a modem or a router.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a PC, hand held computing device, telephone, mobile computing device, workstation, server, minicomputer, mainframe computer, or any other computing device. The computer can also include different bus configurations, networked platforms, multi-processor platforms, and so forth. Various operating systems can be used, including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a Central Processing Unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as system Random Access Memory (RAM). Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for exemplary, a floppy disk, a flexible disk, a hard disk, magnetic tape, any other magnetic medium, a CD-Read-only Memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by a user device including but not limited to one or more of web sites, domains, web pages, web addresses, hyperlinks, URLs, any text, pictures, and/or media (such as video, audio, and any combination of audio and video) provided or displayed on a web page, and any combination thereof. An advisory policy may include any of blocking, constraining, enabling, redirecting, promoting, demoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for encouraging responsible online behavior, the method comprising:
utilizing a user interface between a network user with administrative authority and an Internet service;
receiving advisory parameters to establish an advisory policy for the Internet service from the network user with administrative authority via the user interface, wherein the advisory parameters include the affected Internet content and a message; and
applying the advisory policy to a user request to access the Internet content, a policy enforcement module determining whether or not the advisory policy is in effect to advise the network user against accessing the Internet content.

2. The method of claim 1, wherein the user interface provides a mechanism for activating and deactivating the advisory policy.

3. The method of claim 1, wherein the label refers to Internet content or is a category of Internet content.

4. The method of claim 3, wherein the label refers to a subset of an Internet content or a category of Internet content.

5. The method of claim 3, further comprising automatically determining from the label Internet content or the category of Internet content.

6. The method of claim 3, further comprising automatically selecting, based on the label, one or more Internet sites associated with the advisory policy.

7. The method of claim 6, further comprising enabling the network user with administrative authority to review and modify the one or more Internet sites associated with the advisory policy.

8. The method of claim 6, wherein applying the advisory policy to the user request to access the Internet content comprises:
receiving, from a network user, a request to access the Internet content;
determining that the advisory policy is activated and the Internet content is associated with the one or more Internet sites contained in the advisory policy; and
based on the determination, redirecting the network user to an intermediary Internet site, the intermediary Internet site including the message advising the network user against accessing the Internet content.

9. The method of claim 8, further comprising enabling the network user to disable the advisory policy with respect to the Internet content.

10. The method of claim 9, further comprising periodically sending a reminder to the network user accessing the Internet content, the reminder advising the network user against accessing the Internet content.

11. The method of claim 1, wherein a mechanism is provided for the end user to disable the advisory policy after the end user has received a notification or advisory page indicating an attempt to access Internet content identified by the advisory policy.

12. The method of claim 11, wherein the advisory policy is implemented based on a specified time of day or duration of a session.

13. The method of claim 11, wherein a history of all notifications is stored and is accessible for processing, analysis, and reporting.

14. The method of claim 1, wherein a history of all access to Internet content is stored and is accessible for processing, analysis, and reporting.

15. The method of claim 1, where a different advisory policy is used for different categories of Internet content or Internet websites.

16. The method of claim 13, where multiple advisory policies are associated with Internet sites in a single category of Internet content.

17. The method of claim 1, wherein any end user can create and activate a personalized advisory policy.

18. The method of claim 1, wherein multiple advisory policies are simultaneously applied to multiple end users.

19. The method of claim 11, wherein the notification is customized based on the Internet content or Internet sites that triggered the notification.

20. The method of claim 1, wherein advisory policies are recommended to the administrative user based on end user behavior.

21. The method of claim 1, wherein the Internet service monitors end user internet activity and offers suggestions for advisory policy specific to end users.

22. The method of claim 21, wherein the Internet service suggests additional Internet services or applications to user with administrative authority.

23. The method of claim 1, wherein at least one element of the advisory policy is resident on a DNS server.

24. The method of claim 1, wherein at least one element of the advisory policy is enforced by a DNS server.

25. The method of claim 1, wherein the network user with administrative authority specifies different advisory policies for different locations.

26. The method of claim 1, wherein at least one element of the Internet service resides on a user device.

27. A system for encouraging responsible online behavior, the system comprising:
a user interface module to provide a user interface between a network user with administrative authority and an Internet service;
a communication module to receive advisory parameters from the network user with administrative authority via the user interface, the advisory parameters to establish an advisory policy for the Internet service, wherein the advisory parameters include affected Internet content and a message;
a policy generating module to establish, based on the advisory parameters, the advisory policy for the network; and
a policy enforcement module to apply the advisory policy to a network user request to access the Internet content, the policy enforcement module determining whether or not the advisory policy is in effect to advise the network user against accessing the Internet content.

28. The system of claim 27, further comprising a policy activation module to activate and deactivate the advisory policy.

29. The system of claim 27, wherein the label is an Internet site name or a category name.

30. The system of claim 29, further comprising a label classifier to automatically determine whether the label is the Internet site name or the category name.

31. The system of claim 29, further comprising an Internet site selecting module to automatically select, based on the label, one or more Internet site associated with the advisory policy.

32. The system of claim 31, further comprising an Internet site review module to enable the network user with administrative authority to review and modify the one or more websites associated with the advisory policy.

33. The system of claim 32, wherein the policy enforcement module is to:
receive, from a network user, a request to access the Internet content;
determine that the advisory policy is activated and the Internet content is associated with the one or more Internet sites contained in the advisory policy; and
based on the determination, redirect the network user to an intermediary Internet site, the intermediary Internet site including the message advising the network user against accessing the Internet content.

34. The system of claim 33, wherein the policy enforcement module is to enable a deactivation of the advisory policy with respect to the Internet content.

35. The system of claim 34, further comprising a reminder module to periodically send a reminder to the network user accessing the Internet content, the reminder advising the network user against accessing the Internet content.

36. The system of claim 27, further comprising a policy modification module to receive from the network user a further request to modify the advisory policy, the request including further advisory parameters, and to modify the advisory policy based on the further advisory parameter.

37. The system of claim 27, wherein at least one element of the advisory policy is resident on a DNS server.

38. The system of claim 27, wherein at least one element of the advisory policy is enforced by a DNS server.

39. The system of claim 27, wherein the network user with administrative authority specifies different advisory policies for different locations.

40. The system of claim 27, wherein at least a portion of the advisory policy is resident on a user device.

41. The system of claim 27, wherein at least a portion of the Internet service is resident on a user device.

42. A non-transitory computer readable storage medium having a program embodied thereon, the program executable by a processor in a computing device to perform a method for encouraging responsible online behavior, the method comprising:
utilizing a user interface between a network user with administrative authority and an Internet service;
receiving advisory parameters from the network user with administrative authority via the user interface, the advisory parameters to establish an advisory policy for the Internet service, wherein the advisory parameters include a label associated with an Internet content and a message;
confirming the advisory policy with the network user with administrative authority; and
applying the advisory policy to a user request to access the Internet content, a policy enforcement module determining whether or not the advisory policy is in effect to advise the network user against accessing the Internet content.

43. A method for encouraging responsible online behavior, the method comprising:
utilizing a user interface between a network user with administrative authority and the Internet service;
receiving advisory parameters to establish an advisory policy in the DNS server, wherein the advisory parameters include one or more Internet sites, each Internet site being associated with an Internet content and a message; and
applying the advisory policy to a user request to access the Internet content, the DNS server determining whether or not the advisory policy is in effect to advise the network user against accessing the Internet content.

44. The method of claim 43, wherein the network user with administrative authority specifies different advisory policies for different locations.

45. The method of claim 43, wherein the user interface provides a mechanism for activating and deactivating the advisory policy in the DNS server.

46. The method of claim 43, wherein the Internet site refers to Internet content or is a category of Internet content.

47. The method of claim 43, further comprising enabling the network user with administrative authority to review and modify the one or more Internet sites associated with the advisory policy.

48. The method of claim 43, wherein applying the advisory policy in the DNS server to the user request to access the Internet content comprises:
receiving, from a network user, a request to access the Internet content;
determining in the DNS server that the advisory policy is activated and the Internet content is associated with the one or more Internet sites contained in the advisory policy; and
based on the determination at the DNS server, redirecting the network user to an intermediary Internet site, the intermediary Internet site including the message advising the network user against accessing the Internet content.

49. The method of claim 48, further comprising enabling the network user to disable the advisory policy in the DNS server with respect to the Internet content.

50. The method of claim 48, further comprising periodically sending a reminder to the network user accessing the Internet content, the reminder advising the network user against accessing the Internet content.

51. The method of claim 43, wherein a mechanism is provided for the end user to disable the advisory policy in the DNS server after the end user has received a notification or advisory page indicating an attempt to access Internet content identified by the advisory policy.

52. The method of claim 43, wherein the advisory policy is implemented in the DNS server based on a specified time of day or duration of a session.

53. The method of claim 43, wherein a history of all notifications of activation of the advisory policy is stored and is accessible for processing, analysis, and reporting.

54. The method of claim 43, wherein a history of all access to Internet content is stored and is accessible for processing, analysis, and reporting.

55. The method of claim 43, wherein a different advisory policy is used for different categories of Internet content or Internet websites.

56. The method of claim 43, where multiple advisory policies are associated with Internet sites in a single category of Internet content.

57. The method of claim 43, wherein any end user can create and activate a personalized advisory policy.

58. The method of claim 43, wherein multiple advisory policies are simultaneously applied to multiple end users.

59. The method of claim 53, wherein notifications are customized based on the Internet content or Internet sites that triggered the notification.

60. The method of claim 43, wherein advisory policies are recommended to the administrative user based on end user behavior.

61. The method of claim 43, wherein the DNS server monitors end user internet activity and offers suggestions for advisory policy specific to end users.

62. The method of claim 61, wherein the Internet service suggests additional Internet services or applications to user with administrative authority.

63. A system for encouraging responsible online behavior, the system comprising:
a user interface module to provide a user interface between a network user with administrative authority and a DNS server;
a communication module to receive advisory parameters from the network user with administrative authority via the user interface, the advisory parameters to establish an advisory policy for an Internet service, wherein the advisory parameters include a label associated with an Internet content and a message;
a policy generating module to establish, based on the advisory parameters, the advisory policy for the network; and
a policy enforcement module to apply the advisory policy to a network user request to access the Internet content, the policy enforcement module determining whether or not the advisory policy is in effect to advise the network user against accessing the Internet content.

64. The system of claim 63, further comprising a policy activation module to activate and deactivate the advisory policy.

65. The system of claim 63, wherein the label is an Internet site name or a category name.

66. The system of claim 65, further comprising a label classifier to automatically determine whether the label is the Internet site name or the category name.

67. The system of claim 65, further comprising an Internet site selecting module to automatically select, based on the label, one or more websites associated with the advisory policy.

68. The system of claim 67, further comprising a Internet site review module to enable the network user with administrative authority to review and modify the one or more websites associated with the advisory policy.

69. The system of claim 68, wherein the policy enforcement module is to:
receive, from a network user, a request to access the Internet content;
determine that the advisory policy is activated and the Internet content is associated with the one or more websites; and
based on the determination, redirect the network user to an intermediary Internet site, the intermediary Internet site including the message advising the network user against accessing the Internet content.

70. The system of claim 69, wherein the policy enforcement module is to enable a deactivation of the advisory policy with respect to the Internet content.

71. The system of claim 70, further comprising a reminder module to periodically send a reminder to the network user accessing the Internet content, the reminder advising the network user against accessing the Internet content.

72. The system of claim 63, further comprising a policy modification module to receive from the network user a further request to modify the advisory policy, the request including further advisory parameters, and to modify the advisory policy based on the further advisory parameter.

73. The system of claim 63, wherein at least a portion of the advisory policy is resident on a user device.

74. The system of claim 63, wherein at least a portion of the Internet service is resident on a user device.
